(19) United States
(12) Patent Application Publication
(10) Pub. No.: US 2002/0118280 A1
(43) Pub. Date: Aug. 29, 2002

(54) Positioning device for an imaging diagnosis system

(75) Inventors: Donal Medlar, Weisendorf (DE); Matthias Seufert, Oberreichenbach (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/081,225

(22) Filed: Feb. 22, 2002

(30) Foreign Application Priority Data
Feb. 26, 2001 (DE) 10109219.9

(51) Int. Cl. H04N 7/18

(52) U.S. Cl. 348/77

(57) ABSTRACT

A positioning device for a diagnostic imaging system includes a patient bed on which a patient can be moved from an exterior preparation position into the diagnosis system, a picture screen and one or more cameras arranged over and/or next to the patient bed in the region of the preparation position and that is coupled with the picture screen and a computer. The desired examination region is selected in the patient image on the picture screen with a region selection device in order to automatically move the patient with the selected examination region into the diagnostic imaging system, the patient being on a patient bed provided with a position acquisition device.

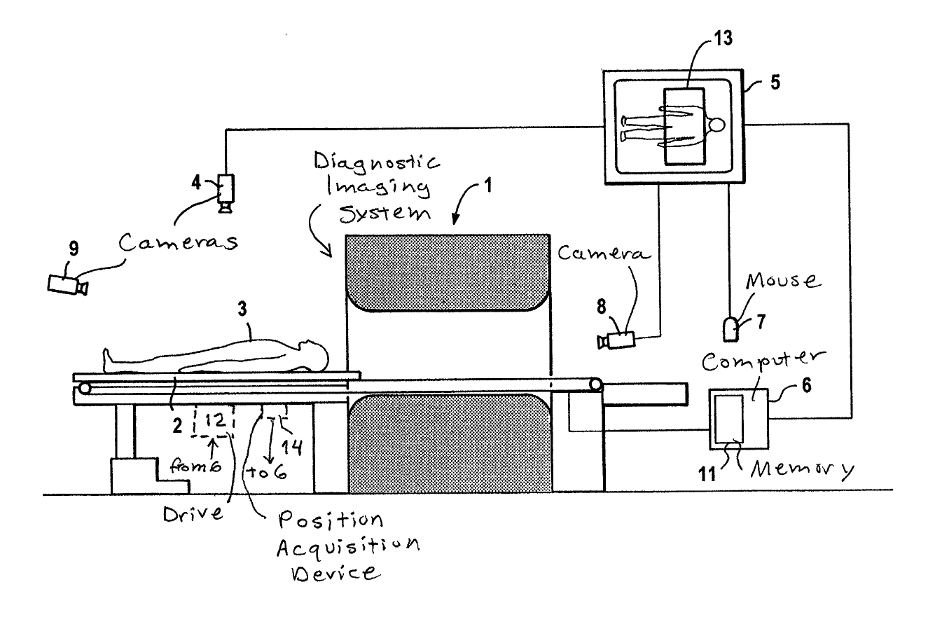

### BACKGROUND OF THE INVENTION

1. Field of the Invention

The present invention is directed to a positioning device for an imaging diagnosis system of the type having a patient bed on which a patient can be moved from an exterior preparation position into the diagnosis system, a picture screen, and one or more cameras is arranged over and/or next to the patient bed in the region of the preparation position and coupled with the picture screen, and a computer.

2 . Description of the Prior Art

It is essential in all diagnosis systems that the body part of the patient to be examined must be positioned in the central region of the device. Usually this ensues by manual displacement of the patient under a laser aiming device. The region to be examined is coarsely identified in on with the laser, and an automatic positioning of this location then is effected in the central region.

German OS 195 08 715 discloses attachment of a marking on the patient in the region of the desired examination region, the spatial position thereof being determined with the assistance of a video camera outside of the examination space of a diagnosis device. The position determined in this way is employed for the targeted position of the patient bed.

In scanning imaging diagnosis systems, the determination of the scan length or the scan region ensues on a separate picture screen. A screen scan of the patient is thereby usually also implemented in advance, the image planes then being entered with reference to the screens can result.

This positioning that has been conventionally undertaken is rather complicated, particularly in the case of scanning devices, and is also some what imprecise, as well as being relatively time-consuming, so that the overall examination time is lengthened as a result, and thus the utilization of the expensive imaging diagnosis devices remain unsatisfactory.

### SUMMARY OF THE INVENTION

An object of the present invention is to provide a positioning device for imaging diagnosis systems of the type initially described wherein a simple, fast and exact positioning of every desired body part in the center of the device can be achieved.

This object is achieved in accordance with the invention in a diagnostic imaging system wherein the desired examination region can be selected in the patient image on the picture screen with a region selection device in order to automatically move the patient with the selected examination region into the imaging diagnosis system, the patient being on a patient bed provided with a position acquisition device. The selected examination region is brought into a central region or in some other optimum region of the diagnostic imaging system.

The region selection device, for example, can be a mouse and/or a touch screen.

Particularly in a scanning, imaging diagnosis system, not only the selection of the desired examination region in view of its central position can be selected via a mouse, a touch screen or the like, but also a scan length and/or a scan region can be selected, with the exact position and size of the scan region being displayed in the picture screen over a selection frame. In conjunction with the fixed camera position and the examination region selected in the overall image of the patient on the picture screen, the computer can move the patient bed, controlled in this way, provided with a position acquisition device into the apparatus, so that the selected examination region that is displayed on the picture screen is exactly arranged in the center of the imaging apparatus, and thus in the optimum examination region.

A memory can be allocated to the computer so that a renewed region selection for examination of the patient in the entered examination region can ensue from stored image data. The patient, who, for example, has been first introduced into the imaging diagnosis system for an examination of the shoulder, thus need not be moved out for a following examination of the knee joint in order to newly enter this further position. Instead it suffices to identify the further region to be examined in the image with the mouse or the touch screen on the picture screen, so that the computer then can automatically move the patient bed into the position that is optimum for this examination. Of course, it is assumed that the position of the patient on the patient bed remains unchanged.

It is also within the framework of the invention to provide a plurality of cameras for plane selection or region selection in two or three dimensions, particularly one camera over the patient and one next to the patient bed in the preparatory position outside the imaging diagnosis system.

### DESCRIPTION OF THE DRAWING

The single FIGURE is a side view, shown partly in section, of a diagnostic imaging system constructed in accordance with the principles of the present invention.

### DESCRIPTION OF THE PREFERRED EMBODIMENTS

The schematically illustrated diagnostic imaging system 1 can, for example, be a magnetic resonance system, a computer tomography system or a nuclear medicine device or the like. The diagnosis system is provided with a moveable bed 2 that is moveable into the inside of the apparatus from the preparatory position shown in the figure. The patient 3 is brought onto the patient bed 2 by a gurney or the like and can in turn be shifted later back onto the gurney. It is important that the displacement ensues to such an extent that the body part of the patient 3 that is to be examined is arranged exactly in the central region of the imaging diagnosis system, i.e., for example, the head, the shoulder, the knee or the liver. In order to be able to accomplish this particularly quickly and simply, a positioning device is inventively provided that is composed of a camera 4 arranged at a fixed position, such as over the patient bed 2 in the preparatory position, so that the field of view of the camera 4 includes at lease a portion of the patient on the patient bed 2 in the preparatory position. The camera 4 is connected to a picture screen 5 and a computer 6 that controls the drive mechanism 12 for the patient bed 2. Using a mouse 7, a touch screen or the like, the attending physician or the medical technical assistant can target the desired region 13 of the patient 3 imaged on the picture screen 5 that is to be examined in the imaging diagnosis system 1—the entire chest and abdominal region in the present case. A smaller region such as, for example, the head or a knee, of course also can be targeted and the scan length and the entire scan region can be pre-selected using a mask.

From the displacement of the scan region relative to the middle of the picture screen that, of course, corresponds to the position of the camera 4, the computer 6 can recognize the spatial offset of the region 13 to be examined and can control the patient bed 2 provided with a position acquisition device 14 into a position so that it is exactly the scan region, that is in the center of the device 1, i.e. where the best images can be made. Another camera 8 can be optionally provided for patient observation, which also can serve the purpose allowing slices to be selected in addition to the two-dimensional acquisition of the patient 3 with the camera 4. Thus a plane selection or region selection in two or three dimensions. Preferably, however, instead of the patient-monitoring camera being used for this purpose, a second camera is provided next to the patient bed. Also, a collision monitoring camera 9 is provided to prevent a body part of the patient 3 or a supply hose or the like from being shifted laterally too far from the center, so that it could strike against the imaging diagnosis system 1 when introduced thereinto.

A component of the computer 6 is a memory 11 in which image data of the patient image and position data with respect to the desired examination region 13 can be stored, so that another region selection, i.e. a renewed positioning, is possible by reading out that data without the patient 3 having to be moved out of the diagnosis device for defining the region, which can be a different region.

Although modifications and changes may be suggested by those skilled in the art, it is in the intention of the inventors to embody within the patent warranted hereon all changes and modifications as reasonably and properly come within the scope of their contribution to the art.

We claim as our invention:

1. A positioning device for a diagnostic imaging system, comprising:
a patient support having a table adapted to receive a patient thereon which is movable between a preparation position, outside of said diagnostic imaging system, to an interior position within said diagnostic imaging system;
a camera having a field of view which includes at least a portion of said patient bed in said preparation position;
said patient bed having a position acquisition device which generates a signal indicating a position of said table;
a picture screen connected to said camera for displaying an image in said field of view of said camera;
a region selection device which interacts with said picture screen to designate a desired examination region in the image on the picture screen; and
a computer connected to said picture screen and to said patient bed, and receiving said signal from said position acquisition device, for automatically moving said table and said patient to a position within said diagnostic imaging system needed for obtaining an image of said examination region.

2. A positioning device as claimed in claim 1 wherein said region selection device is a computer mouse.

3. A positioning device as claimed in claim 1 wherein said picture screen is a touch screen forming said region selection device.

4. A positioning device as claimed in claim 1 wherein said region selection device also enters at least one of a scan length and a scan region associated with said examination region via said picture screen.

5. A positioning device as claimed in claim 1 further comprising a memory accessible by said computer wherein the position of said table needed for obtaining said image of said examination region is stored.

6. A positioning device as claimed in claim 1 further comprising an input unit allowing entry of image planes in advance of obtaining said image of said examination region.

7. A positioning device as claimed in claim 1 comprising at least one further camera having a field of view which is also displayable on said picture screen to allow selection of a region having at least two dimensions as said examination region.
